(19) United States
(12) Patent Application Publication
(10) Pub. No.: US 2004/0115397 A1
(43) Pub. Date: Jun. 17, 2004

(54) Protective strap for handle

(76) Inventor: Mao-Hsiu Wang, Taichung Hsien (TW)

Correspondence Address: BACON & THOMAS, PLLC, 625 SLATERS LANE, FOURTH FLOOR, ALEXANDRIA, VA, 22314

(21) Appl. No.: 10/320,456

(22) Filed: Dec. 17, 2002

(51) Int. Cl. B32B 3/10

(52) U.S. Cl. 428/138

(57) ABSTRACT

A protective strap is disclosed to include an elongated strap body adapted for spirally winding around a handle. The strap body has a top gripping layer for a user's hand gripping and a bottom layer bonded to the gripping layer. The gripping layer is made of a rubber material. The bottom layer is smaller than the gripping layer in density and ductibility. Additionally, the strap body of the protective strap reduces decreasingly from an end thereof to the other end thereof along the direction of a longitudinal axle thereof in thickness.

### FIELD OF THE INVENTION

The present invention relates generally to a protective strap, and more particularly to a protective strap for use in a handle of a sports apparatus.

### BACKGROUND OF THE INVENTION

A conventional protective strap is formed of a gripping layer, a nonwoven fabric layer, and a rubber layer or, as shown in FIGS. 1 and 2, is simply formed of a gripping layer 1 and a nonwoven fabric layer 2. The gripping layer 1 is generally made by foaming of polyurethane (PU), which is fairly comfortable for hands holding. However, the foaming of PU is defective in that while the protective strap is wound around a handle of a sports apparatus, the more the outer diameter of the protective strap extends outwardly, the more the radius of curvature of the protective strap increases. Accordingly, the foaming of PU of the gripping layer is excessively stretched or undermined in process of winding around the handle by a preload force such that the protective strap is in deficiency of shock-absorption or low durability.

Furthermore, although the foaming of PU is preferably comfortable for hands holding, while hitting the sports apparatus in high speed, the handle is apt to slip away from the hand and then accidents of hurting neighboring audiences would occur due to the foaming of PU incapable of being skidproof. In other words, the conventional protective strap, which gripping layer is made of PU, is defective in inefficient shock-absorption, low durability, and slipperiness.

Additionally, the weight of the sports apparatus is also a significant factor for the improvement of a prior art sports apparatus. On the basis of keeping the hardness of the sports apparatus, for the manufacturers of sports apparatuses and protective straps, the solutions of reducing the weight of the sports apparatus are still behind their reach. In the meantime, the solutions of providing better gripping performance are also still behind their reach for those manufacturers.

### SUMMARY OF THE INVENTION

The primary objective of the present invention is to provide an improved protective strap, which is provided with better ductibility, larger density, more efficient shock-absorption, and higher durability than the prior art.

Another objective of the present invention is to provide an improved protective strap, which is more skidproof than the prior art.

Still another objective of the present invention is to provide an improved protective strap, which is lightweight and effective in better gripping performance than the prior art.

In keeping with the principle of the present invention, the foregoing objectives of the present invention are attained by the protective strap, which comprises an elongated strap body adapted for spirally winding around a handle. The strap body has a top gripping layer made of rubber for a user's hand gripping, and a bottom layer bonded to a bottom side of the gripping layer at a top side thereof and being smaller than said gripping layer in density, ductibility and resilience The rubber material is extremely ductile such that the protective strap will not be undermined while being wound around the handle, and is highly dense so as to be capable of absorbing shock. Additionally, the rubber material is skidproof for the user to hold the gripping layer tight instead of slipperiness.

Furthermore, the protective strap reduces decreasingly from an end thereof to the other end thereof along the direction of a longitudinal axle of the protective strap in thickness so as to reduce the weight of a sport apparatus. Meanwhile, the taper of the longitudinal profile of the handle around which the protective strap is wound will be preferably great.

### BRIEF DESCRIPTION OF THE DRAWINGS

FIG. 1 is a perspective view of a conventional protective strap wound around a handle of a sports apparatus;

FIG. 2 is a partial sectional enlarged view taken along the direction indicated by a line 2-2 as shown in FIG. 1;

FIG. 3 is a perspective view of a first preferred embodiment of the present invention;

FIG. 4 is a side view of the first preferred embodiment of the present invention;

FIG. 5 is a sectional view of the protective strap of the first preferred embodiment of the present invention wound around the handle of a sports apparatus;

FIG. 6 is a side view of a second preferred embodiment of the present invention;

FIG. 7 is a side view of a third preferred embodiment of the present invention;

FIG. 8 is a sectional view of a fourth preferred embodiment of the present invention;

FIG. 9 is a sectional view of a fifth preferred embodiment of the present invention;

FIG. 10 is a schematic view of the protective strap of the fifth preferred embodiment of the present invention pressed by a hand; FIG. 11 is a perspective view of the fifth preferred embodiment of the present invention wound around the handle of a sports apparatus; and

FIG. 12 is a sectional view of a sixth preferred embodiment of the present invention.

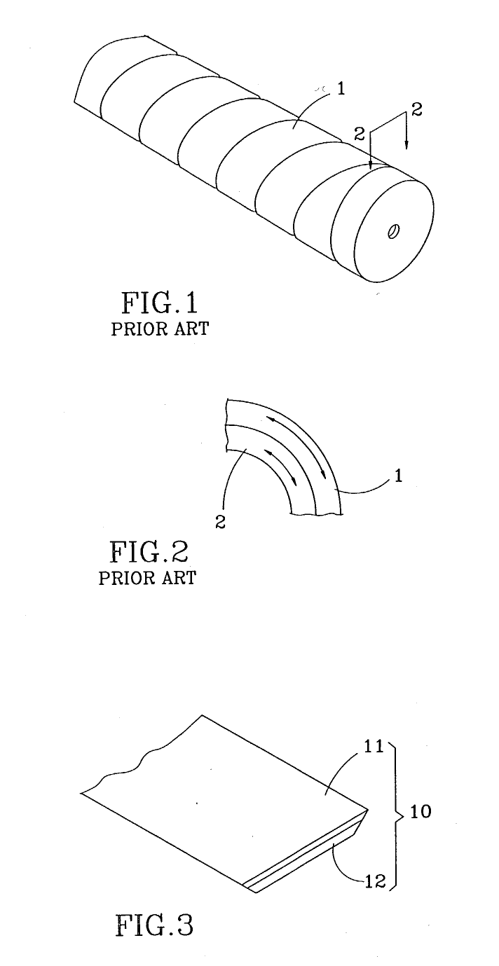

### DETAILED DESCRIPTION OF THE INVENTION

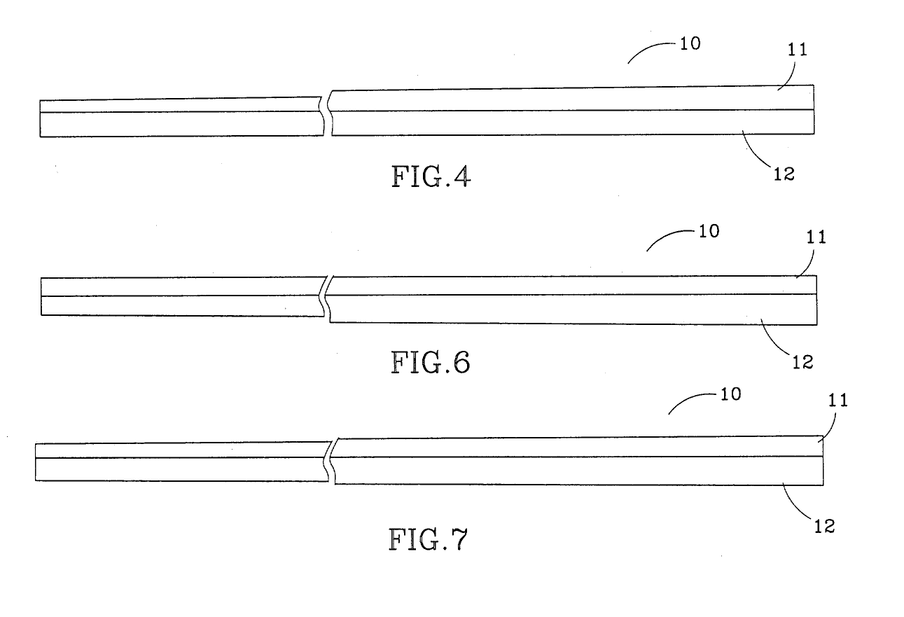

Referring to FIGS. 3-5, a protective strap of a first preferred embodiment of the present invention comprises an elongated strap body 10, which is formed of a gripping layer 11 and a bottom layer 12. The gripping layer 11 is located at the top of the strap body 10 for a hand holding and is made of a material characterized by effects of being extremely dense, ductile, resilient, skidproof, and so on, wherein the material can be rubber at best. The effect of being extremely ductile prevents the gripping layer 11 from being undermined or less durable due to being bent and stretched too much while the gripping layer 11 is wound around a handle by a preload. The effect of being extremely dense provides the gripping layer 11 with excellent shock-absorption while holding the handle to hit. The effect of being extremely skidproof prevents the gripping layer 11 from slipping away from the hand while holding the handle to hit in high speed. Additionally, the gripping layer 11 of the strap body reduces decreasingly from an end thereof to the other end thereof along the direction of a longitudinal axle thereof in thickness ranging from 1.2 mm to 0.6 mm, as shown in FIG. 4. The bottom layer 12 is located at the bottom of the strap body 10 and is adhered to a bottom side of the gripping layer 11 at a top side thereof. The bottom layer 12 is made of a material, which is less ductile, resilient, and dense than the material of the gripping layer 11, such as polyurethane (PU) or ethylene vinyl acetate (EVA) at best. PU is preferable for the gripping layer 11 if the gripping performance is priorly considered. EVA is preferable for the gripping layer 11 if the shock-absorption is priorly considered. There are still alternative materials capable of absorbing shock for the gripping layer 11. The thickness of the bottom layer 12 is 1.2 mm and is no less than the thickness of the gripping layer 11 such that the thickness ratio of the gripping layer 11 to the bottom layer 12 ranges from 1:2 to 1:1. The aforesaid structure reveals not only aforementioned characteristics of the rubber material but also comfortableness and shock-absorption characteristic of the preferably thin bottom layer 12. At the same time, the taper (β) of a longitudinal profile of the sports apparatus handle around which the protective strap is wound is greater than the taper (α) of a longitudinal profile of the bare sports apparatus handle such that the gripping layer 11 reduces decreasingly in thickness so as to reduce the weight for the sports apparatus. Besides, the handle around which the protective strap is wound is efficient in the gripping performance such that the sports apparatus can be tightly held to hit laborsavingly and the aforementioned characteristics of the bottom layer 12 can preferably work while the protective strap is wound around the sports apparatus.

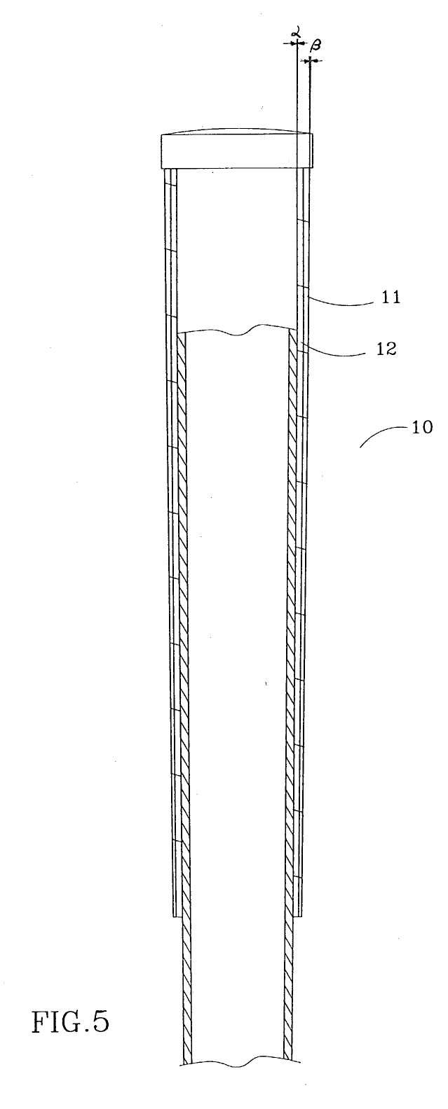

Referring to FIG. 6, the protective strap of a second preferred embodiment of the present invention different from the first embodiment lies in that the thickness of the gripping layer 11 is axially uniformly 0.9 mm and the bottom layer 12 reduces axially decreasingly from an end thereof to the other end thereof along the direction of a longitudinal axle of the gripping layer 11 and ranges from 0.9 mm to 1.5 mm in thickness. Referring to FIG. 7, the protective strap of a third embodiment of the present invention different from the first embodiment lies in that the gripping layer 11 and the bottom layer 12 reduce axially decreasingly and respectively range from 1.0 mm to 0.7 mm and from 1.4 mm to 1.1 mm in thickness.

Referring to FIG. 8, the protective strap of a fourth preferred embodiment of the present invention different from the first embodiment lies in that the gripping layer 11 is provided with a first lip portion 111 at a left side thereof and a second lip portion 112 at a right side thereof. When the protective strap is wound around the handle, the first lip portion 111 is overlapped on the second lip portion 112 such that the protective strap is seamlessly wound around the handle. Alternatively, the first lip portion and the second lip portion can be respectively positioned at a top-left side of the gripping layer 11 and at a bottom-right side of the bottom layer 12.

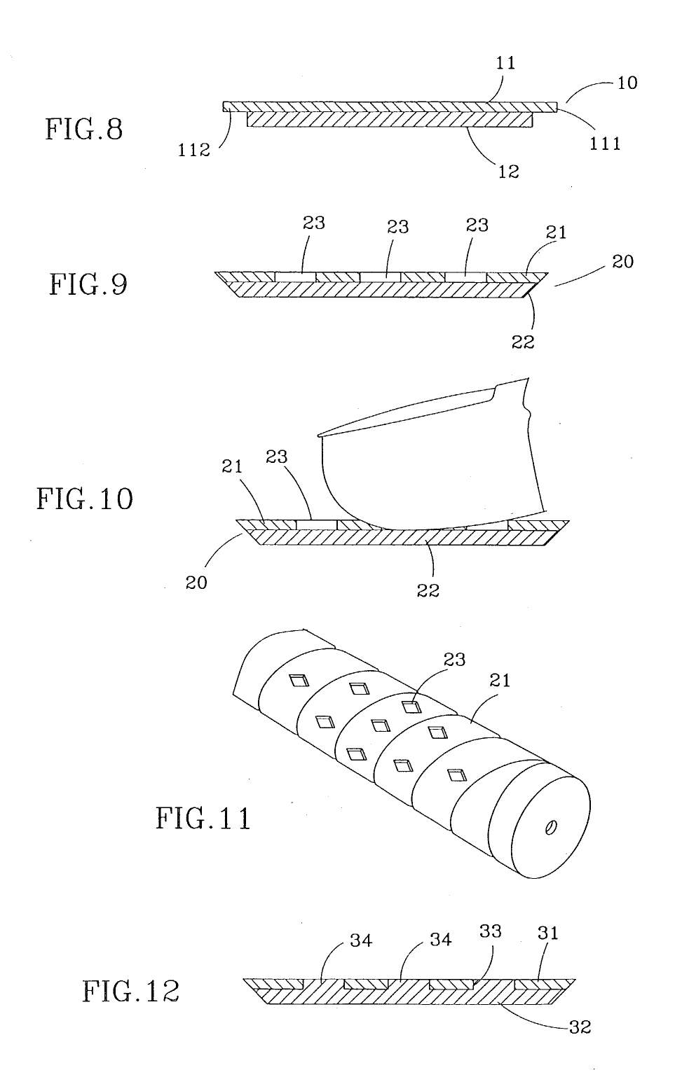

Referring to FIG. 9, the protective strap 20 of a fifth preferred embodiment of the present invention different from the first embodiment lies in that the gripping layer 21 is provided with a plurality of through holes 23, which can be in shape of circle, square, diamond, and freeform and which inner diameters range at least from 4 mm to 8 mm at best. Besides, the deepness of the through holes 23 is the same as the thickness of the gripping layer 21. When the protective strap is held and pressed by the user's hand, the gripping layer 21 of the strap body 20 will be recessed downward to a level substantially equal to the top side of the bottom layer 22 at the area adjacent to the through holes 23, such that the hand can simultaneously touch the gripping layer 21 and the bottom layer 22. In details, if the gripping layer 21 is made of rubber and the bottom layer 22 is made of PU, and when the hand presses the gripping layer 21, the gripping layer 21 will be recessed downward to a level about equal to the top side of the bottom layer 22 at the area adjacent to the through holes 23, such that the bottom layer 22 will be directly in contact with the hand and then the aforesaid characteristics of the materials of which the gripping layer 21 and the bottom layer 22 are made will effectively work on the hand. The through holes 23 can be designed in shape of circle or square or diamond, or a design as which all of the through holes 23 are arranged to combine, such as a trademark name or a trademark logo design, as shown in FIG. 11. Accordingly, the protective strap is preferably aesthetic in shape design and then draws customers' attention, thereby the practicality of merchandise is achieved.

Referring to FIG. 12, the protective strap of a six preferred embodiment of the present invention different from the fifth embodiment lies in that the top side of the bottom layer 32 of the strap body 30 is provided with a plurality of convex portions 34 protruding upwardly, which are in corresponding positions to and are received in the through holes 33 of the gripping layer 31, such that the gripping layer 31 and the bottom layer 32 are preferably tightly engaged and the contact area of the bottom layer 32 in contact with the hand increases. Additionally, the bottom layer 32 is made of PU in the present embodiment and can be alternatively made of EVA or other shock-absorptive materials.

As a conclusion, the advantages of the present invention is described below:

1. Fairly durable, shock-absorptive, skidproof: The rubber material of which the gripping layer of the protective strap is made is characterized by superior ductibility, high density, being well skidproof, etc. When the protective strap is wound around the handle, the present invention can prevent the protective strap from low durability resulted from the protective strap is over-stretched and then is structurally undermined. Besides, the present invention is provided with shock-absorptive effect and is free from slipping away from the hand while holding the sports apparatus to hit in high speed.

2. Double layers effect: The gripping layer is no greater than the bottom layer in thickness or the convex portions of the bottom layer protrude through the through holes of the gripping layer, thereby the hand can feel the aforesaid favorable effects of the rubber material and the comfortable and shock-absorptive effects of the material of the bottom layer.

3. Lightweight and laborsaving: The protective strap reduces axially decreasingly from the end to the other end in overall thickness, and the overall weight of the protective strap is thereby reduced. Besides, the taper of the handle around which the protective strap is wound becomes preferably great such that the gripping performance is preferably good and hitting the sports apparatus is laborsaving.

4. Aesthetic in shape design: The design, which is formed by the shape of the through holes of the gripping layer and the arranged through holes, accompanied with versatile colors of the bottom layer not only satisfies the customers aesthetically but also promotes them to buy, thereby the practicability of merchandise is achieved.

What is claimed is:

1. A protective strap for winding spirally around a handle, comprising:
an elongated strap body having a top gripping layer made of rubber for a user's hand gripping, and a bottom layer bonded to a bottom side of the gripping layer at a top side thereof and being smaller than said gripping layer in ductibility and density;
wherein said strap body reduces decreasingly from an end thereof to the other end thereof along the direction of a longitudinal axle thereof in thickness.

2. The protective strap as defined in claim 1, wherein said gripping layer reduces decreasingly from an end thereof to the other end thereof along the direction of a longitudinal axle thereof in thickness and said bottom layer is uniform in thickness.

3. The protective strap as defined in claim 1, wherein said bottom layer reduces decreasingly from an end thereof to the other end thereof along the direction of a longitudinal axle thereof in thickness and said gripping layer is uniform in thickness.

4. The protective strap as defined in claim 1, wherein said gripping layer and said bottom layer reduce decreasingly respectively from an end to the other end along the direction of the longitudinal axle thereof in thickness.

5. The protective strap as defined in claim 1, wherein said gripping layer is no greater than said bottom layer in thickness.

6. The protective strap as defined in claim 2, wherein said gripping layer ranges from 0.6 mm to 1.2 mm and said bottom layer is 1.2 mm in thickness.

7. The protective strap as defined in claim 1, wherein said bottom layer is made of polyurethane (PU).

8. The protective strap as defined in claim 1, wherein said bottom layer is made of foaming of ethylene vinyl acetate (EVA).

9. The protective strap as defined in claim 1, wherein said gripping layer is provided with a plurality of through holes.

10. The protective strap as defined in claim 9, wherein said bottom layer is provided at the top side thereof with a plurality of convex portions received in said through holes of the gripping layer respectively.

11. The protective strap as defined in claim 9, wherein said through holes ranges from 4.0 mm to 8.0 mm in diameter.
